(19) United States
(12) Patent Application Publication
(10) Pub. No.: US 2008/0029659 A1
(43) Pub. Date: Feb. 7, 2008

(54) Universal Motion Master #3

(76) Inventors: Mark Weber, Dawson, MN (US); Robert Alan Watlov, Rogers, MN (US)

Correspondence Address: WILSON DANIEL SWAYZE, JR., 3804 CLEARWATER CT., PLANO, TX, 75025, US

(21) Appl. No.: 11/833,278

(22) Filed: Aug. 3, 2007

Related U.S. Application Data
(60) Provisional application No. 60/835,709, filed on Aug. 4, 2006.

(51) Int. Cl. A45F 3/44; A01M 31/06

(52) U.S. Cl. 248/156

(57) ABSTRACT

A decoy stand for attachment to a duck decoy includes an attachment member to attach the decoy stand to the duck decoy, a bias member to variably bias the attachment member, a stake member to variably bias the attachment member, a tapered stopper member positioned on the stake member to change the bias of the attachment member and a stand mounting member to allow the decoy stand to be mounted in the ground. The decoy stand includes a receiver member to cooperate with the tapered stopper member, and the bias member includes a spring or elastic material. The decoy stand includes a connecting member to connect to the biasing member to the receiver member, and the decoy stand includes a top sleeve member to connect to the attachment member. The decoy stand includes a bottom sleeve member to attach to the stake member, and the stake member varies from straight to Z shaped.

### PRIORITY

The present application claims priority under 35 USC section 119 based on provisional application Ser. No. 60/835,709 which was filed on Aug. 4, 2006.

### FIELD OF THE INVENTION

The present invention relates to devices associated with game hunting including duck hunting, and more particularly to a device to provide motion to a duck decoy.

### BACKGROUND OF THE INVENTION

Hunters often use decoys to attract prey into an area which the prey would consider safe. Water fowl decoys are well known which mimic the shape and coloration of a water fowl. Various types of decoys are used on land while other types of decoys are used to float in water. The floating decoys are placed by the hunter in water to which the ducks are attracted. The decoys typically have a fowl shaped body made of a buoyant material using a variety of methods. Early decoys were carved from wood which often became water logged and did not last long. Later, decoys were carved from cork. While the cork decoys were more buoyant and lighter to carry, the cork decoys also degraded over time. Recently, most decoys are produced from blown-molded plastic. The decoys are inexpensive and very light weight. However, these decoys are easily damaged and must be replaced often.

Decoys have also been made from styrofoam with cloth covers. However, these decoys are easily torn and destroyed. Also, decoys have been made from urethane foam which produces a solid foam decoy. The solid foam decoy is, however brittle and therefore subject to breakage. This type of foam decoy does not allow the decoy to have detailed features to more accurately mimic a live water fowl.

### SUMMARY

The Universal Motion Master #3 of the present invention provides a holder for a duck decoy to create lifelike walking and feeding motion in a decoy spread. The Universal Motion Master #3 can be attached to a wide range of shell decoys or full-bodied decoys. While the present invention refers to duck decoys, the present invention can be used for any decoy including duck, goose, turkey, crow, big-game and the like to create motion. The Universal Motion Master #3 is simple to install and can be adapted to the pivot point to each style and brand of decoy. The Universal Motion Master #3 can be activated by the wind, manually or by a motor and prevents over exaggerated motion and prevents the unwanted 360° spinning motion of the decoy around its pivot point even in heavy wind. The Universal Motion Master #3 creates lifelike walking and feeding motion in a decoy spread. The decoy mounted on the Universal Motion Master #3 allows for the wind to push the decoy from side to side and up-and-down to create both lifelike walking and feeding motion. The attachment apparatus of the decoy is secure and strong because the Universal Motion Master #3 acts as one-piece preventing the decoy from falling off the stake. The bottom end of the stake could be any of a number of styles and should be easily placed into the ground at the desired decoy location. The length of the stake is such that the decoy stand is at the proper height to imitate bird or animal that the decoy is meant to imitate. Universal Motion Master #3 can be easily removed from the decoy in order to provide for easy stacking and storage of decoys.

A decoy stand for attachment to a duck decoy includes an attachment member to attach the decoy stand to the duck decoy, a bias member to variably bias the attachment member, a stake member to variably bias the attachment member, a tapered stopper member positioned on the stake member to change the bias of the attachment member and a stand mounting member to allow the decoy stand to be mounted in the ground.

The decoy stand includes a receiver member to cooperate with the tapered stopper member, and the bias member includes a spring.

The decoy stand includes a connecting member to connect to the biasing member to the receiver member, and the decoy stand includes a top sleeve member to connect to the attachment member.

The decoy stand includes a bottom sleeve member to attach to the stake member, and the stake member can be any number of shapes, from straight to Z shaped.

The stake member cooperates with the receiver member, and the stake member cooperates with the top sleeve member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the Universal Motion Master #3 of the present invention;

FIG. 2 illustrates an exploded view of the Universal Motion Master #3 of the present invention;

FIG. 3 illustrates a side view of the Universal Motion Master #3 with a shell decoy;

FIG. 4 illustrates a perspective view of the Universal Motion Master #3;

FIG. 5 illustrates a sectional view of the Universal motion Master #3 with a shell decoy;

FIG. 6 illustrates a side view of the Universal motion Master #3 with a shell decoy;

FIG. 7 illustrates a exploded view of another embodiment of the Universal motion Master #3; and

FIG. 8 illustrates an exploded view of another embodiment of the Universal motion Master #3.

### DETAILED DESCRIPTION

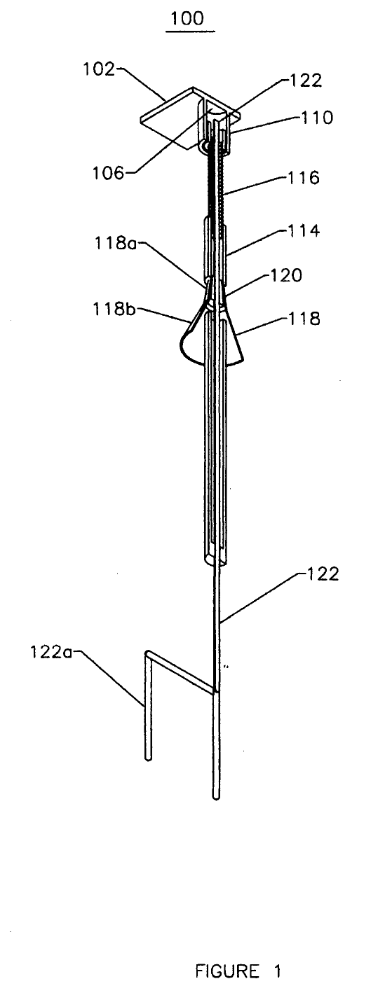

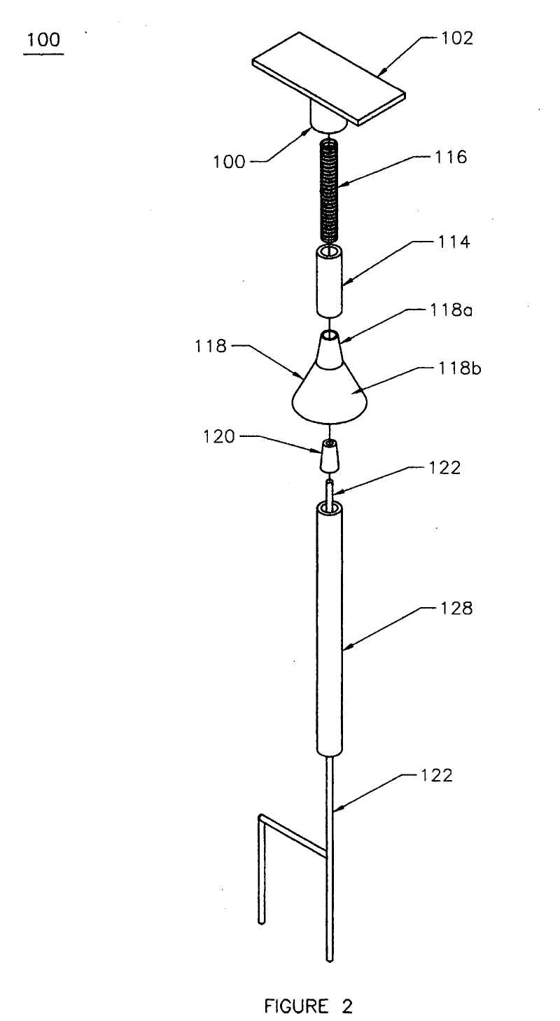

FIG. 1 illustrates the Universal Motion Master #3 or decoy stand 100 to mount a decoy such as a duck decoy which may be either a shell or solid duck decoy. The decoy stand 100 includes an attachment member 102 to mount the shell or solid duck decoy; the attachment member 102 may be a rigid rectangular plate. The top surface of the attachment member 102 may include Velcro or other suitable fastening apparatus in order to connect the decoy stand 100 to the duck decoy. The attachment member 102 is positioned on a top sleeve member 110. The top sleeve member 110 may be a hollow cylinder or tube to be positioned at one end of the stake member 122 as seen in FIG. 1 and may be formed from rigid material. FIG. 1 additionally illustrates a biasing member 116 which may be a spring or elastic material and which is positioned over the stake member 122. The biasing member 116 biases the top sleeve member 110 and the attachment member 102 to provide lifelike motion to the decoy mounted on the attachment member 102. One end of the biasing member 116 is connected to the connector member 114 which travels along the stake member 122 to connect the biasing member 116 to the receiver member 118. The receiver member 118 includes a first tapered section 118a and a second tapered section 118b. The first tapered section 118a of the receiver member 118 cooperates with a tapered stopper member 120 to control the amount of biasing supplied by the biasing member 116 to the decoy. The tapered stopper member 120 may be moved by sliding along the stake member 122 and is held in position on the stake member 122 by a friction fit. The second tapered section 118b guides the tapered stopper member 122 to the first tapered section 118a. This aides in the assembly of the decoy stand 100 in the low light conditions. The stopper member 120 temporarily anchors the stake member 122 inside the tapered receiver member 118 so that the decoy will not spin in the unwanted 360°. At that point, only the biasing member 116 (spring) and the position of the stake member 122 inside the top sleeve member 110 determines the overall motion of the decoy mounted to the attachment member 102. The decoy stand 100 may include a bottom sleeve member 128 as shown in FIG. 2 which can be positioned on the stake member 122 to cooperate with the receiver member 118 and which may be a hollow cylinder. The bottom sleeve may be a cosmetic piece that is not necessary for the functionality of the invention. However, the bottom sleeve may be painted a color to match the natural coloring of the species that the decoy is intended to mimic.

The decoy stand 100 additionally includes a stand mounting segment 122a of the stake member 122 for mounting the decoy stand 100 in the ground, and the stand mounting segment 122a of the stake member 122 which extends out of the bottom sleeve member 118. The stand mounting segment 122a of the stake member 112 is shown as an inverted U shaped device, but could take on many different forms as long as it securely anchors the decoy stand in the ground.

One end of the stake member 122 extends into the top sleeve member 110. The distance that the end of the stake member 122 extends into the top sleeve member 110 determines the amount of movement between the top sleeve member 110 and the stake member 122 and correspondingly limits the amount of vertical motion of the decoy. This in conjunction with the biasing member 116 determines how far and how easily the decoy moves. The stake member 122 extends through the biasing member 116 and into the top sleeve member 110 to provide movement both vertically and horizontally when the biasing member 116 is attached.

FIG. 2 illustrates an exploded view of the decoy stand 100 including the attachment member 102, the top sleeve member 110, the connector member 114, the biasing member 116, the receiver member 118, the tapered stopper member 120, the bottom sleeve member 128 and the stake member 122.

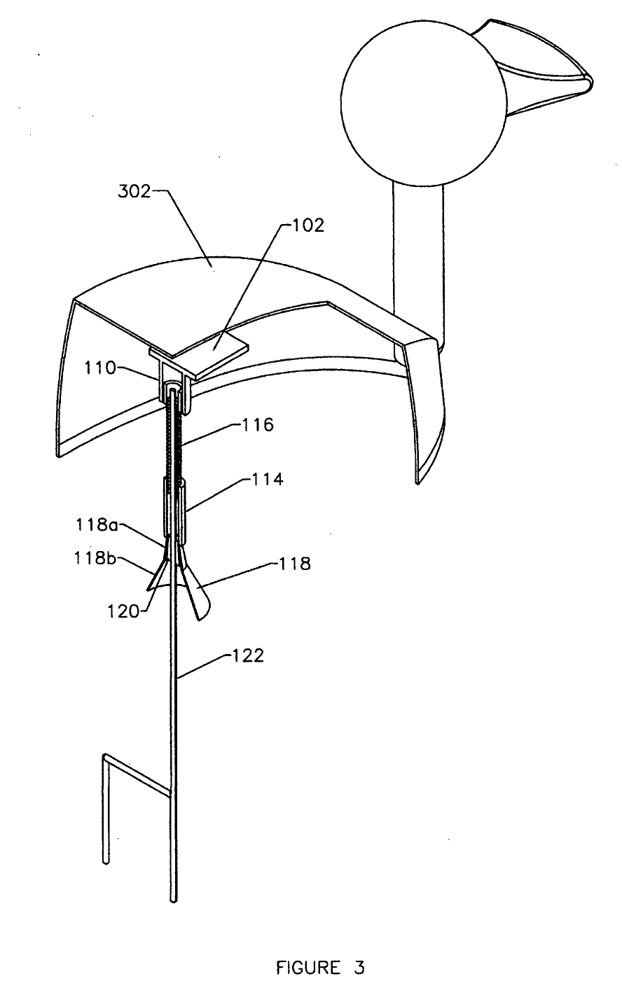

FIG. 3 illustrates a duck decoy 302 mounted on the attachment member 102 connected to the top sleeve member 110 which is connected to the biasing member 116 which is connected to the receiver member 118 which is temporarily mounted on the stopper member 120 and which is mounted on the stake member 122. The position of the tapered stopper member 120 controls the amount of vertical movement of the duck decoy 302. The biasing member 116 biases the top sleeve member 110. The tapered stopper member 120 moves along the stake member 122 to adjust the amount of the stake member 122 that sets up into the top sleeve member 110. The further the stake member 122 sits up into the top sleeve member 110, the less vertical motion the attached decoy will experience. The connector member 114 may be an integral part of the receiver member 118.

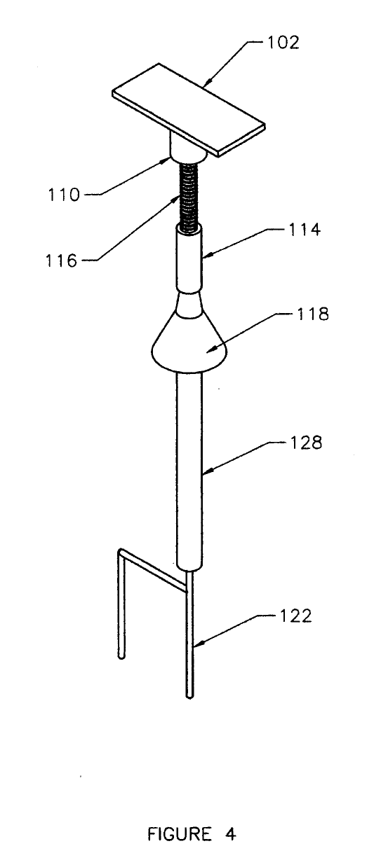

FIG. 4 illustrates a perspective view of the decoy stand 100 of the present invention. The attachment member 102 attaches to the duck decoy, and the biased member 116 variably biases the top sleeve member 110 to allow the duck decoy 302 to have both horizontal and vertical movement.

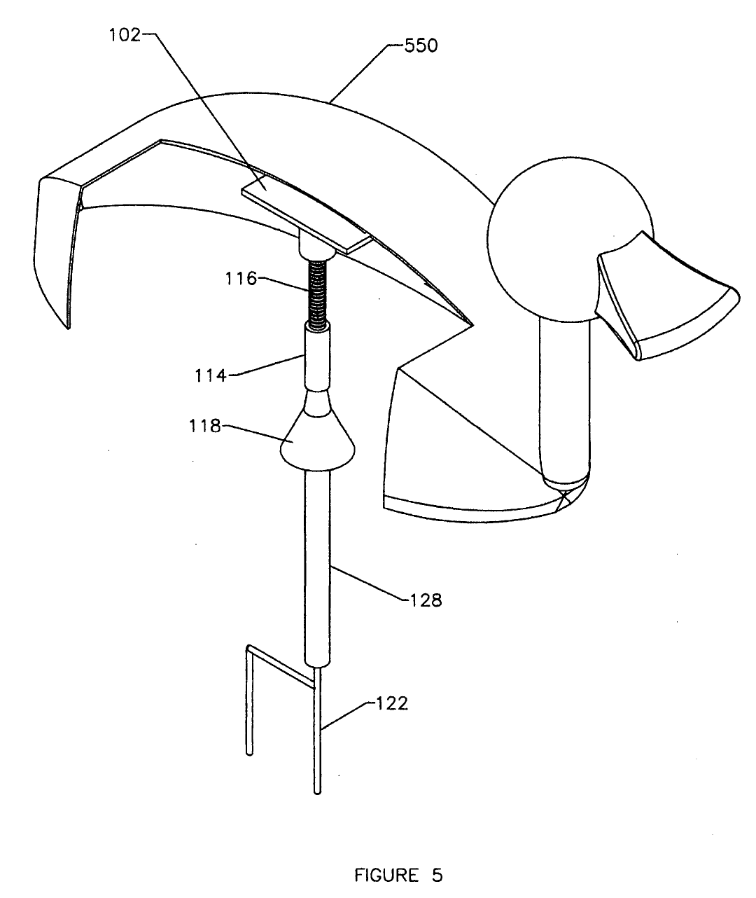

FIG. 5 illustrates the duck decoy 550 and the attachment member 102 for attachment to the duck decoy 330. FIG. 5 additionally illustrates the bias member 116 and the bottom sleeve member 118.

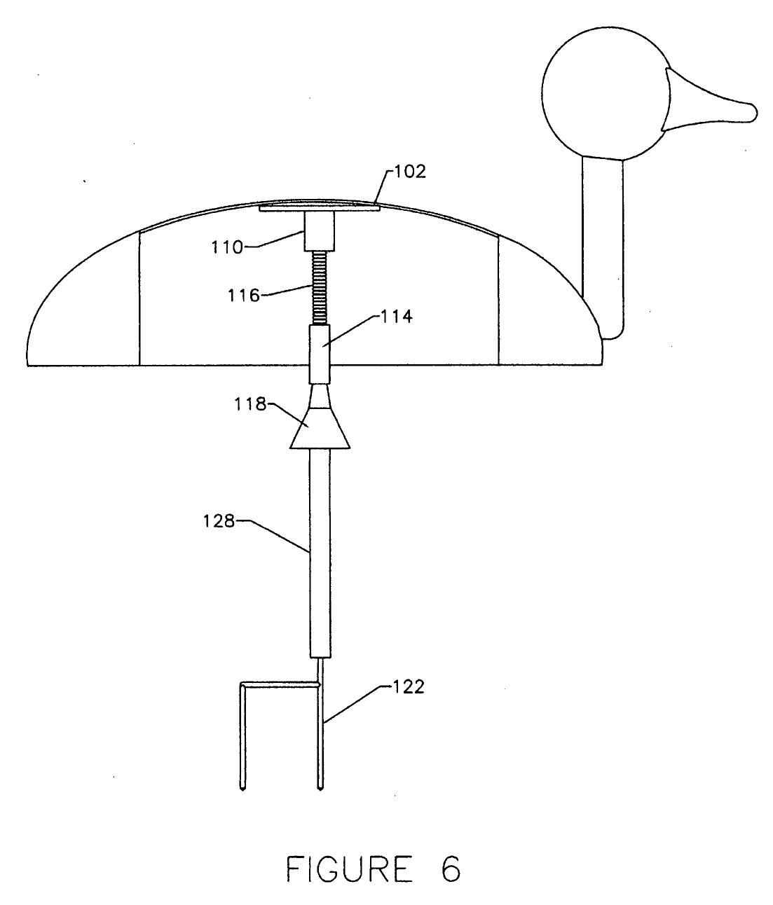

FIG. 6 illustrates a cross-sectional view of the duck decoy of the present invention.

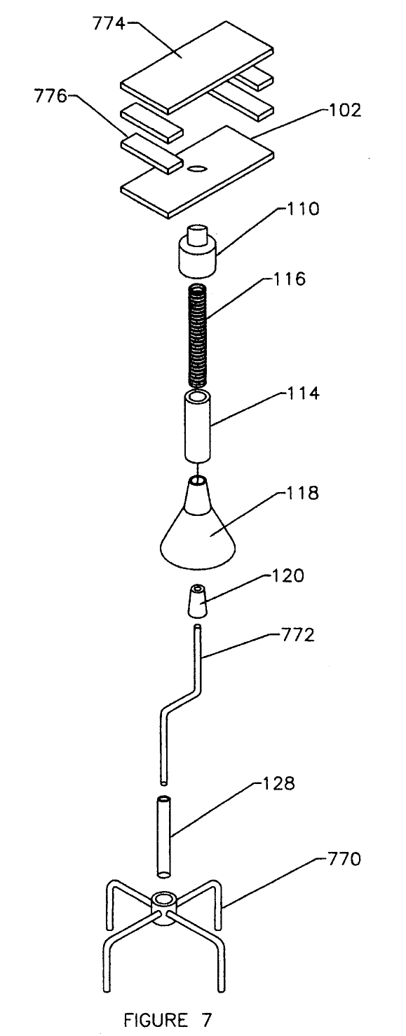

FIG. 7 illustrates another embodiment of the duck decoy of the present invention. FIG. 7 illustrates a detachable foot member 770 which is connected to a Z shaped stake member 772 which is connected to the tapered stopper member 120. FIG. 7 additionally illustrates a mounting member 774 like Velcro for attachment to the attachment member 102. Spacers 776 like Velcro may be connected to the outside ends of the underneath side of the mounting member 774.

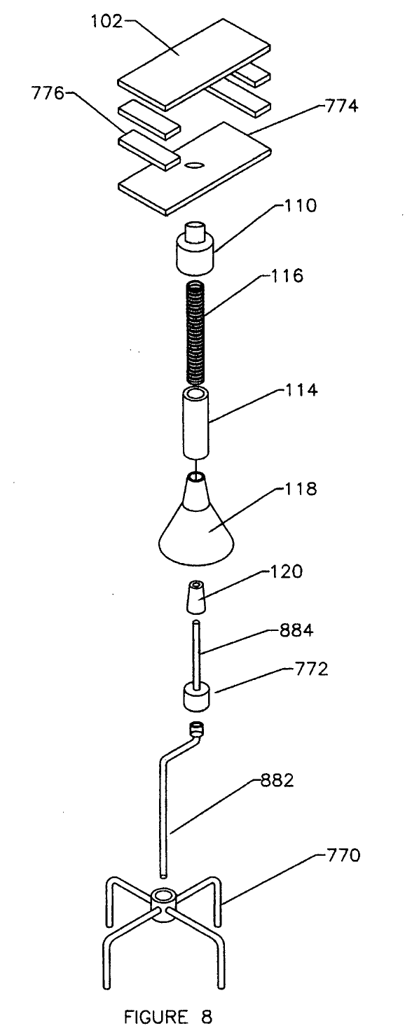

FIG. 8 illustrates that the Z shaped stake member may include a first section 882 and a second section 884 which are detachably connected to each other.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A decoy stand for attachment to a duck decoy, comprising:
an attachment member to attach the decoy stand to the duck decoy;
a bias member to variably bias the attachment member
a stake member to variably bias the attachment member;
a tapered stopper member positioned on the stake member to change the bias of the attachment member; and
a stand mounting member to allow the decoy stand to be mounted in the ground.

2) A decoy stand for attachment to a duck decoy as in claim 1, wherein the decoy stand includes a receiver member to cooperate with the tapered stopper member.

3) A decoy stand for attachment to a duck decoy as in claim 1, wherein the bias member includes a spring.

4) A decoy stand for attachment to a duck decoy as in claim 1, wherein the decoy stand includes a connecting member to connect to the biasing member to the receiver member.

5) A decoy stand for attachment to a duck decoy as in claim 4, wherein the decoy stand includes a top sleeve member to connect to the attachment member.

6) A decoy stand for attachment to a duck decoy as in claim 5, wherein the decoy stand may include a bottom sleeve member to attach to the stake member.

7) A decoy stand for attachment to a duck decoy as in claim 6, wherein the stake member is approximately Z shaped.

8) A decoy stand for attachment to a duck decoy as in claim 2, wherein the stake member cooperates with the receiver member.

9) A decoy stand for attachment to a duck decoy as in claim 5, wherein the stake member cooperates with the top sleeve member.

10) A decoy stand for attachment to a duck decoy as in claim 1, wherein the bias member includes an elastic material.

11) A decoy stand for attachment to a duck decoy as in claim 6, wherein the stake member is approximately straight.
